(19) United States
(12) Patent Application Publication
(10) Pub. No.: US 2012/0162797 A1
(43) Pub. Date: Jun. 28, 2012

(54) ADJUSTABLE REAR-VIEWING SYSTEM FOR VEHICLE

(75) Inventors: Yun Luo, Ann Arbor, MI (US); Dieter Hoetzer, Plymouth, MI (US)

(73) Assignee: ROBERT BOSCH GMBH, Stuttgart (DE)

(21) Appl. No.: 12/978,966

(22) Filed: Dec. 27, 2010

(51) Int. Cl. B60R 1/062; B60R 1/04

(52) U.S. Cl. 359/843

(57) ABSTRACT

A system for adjusting one or more mirror in a vehicle based on an estimated location of the driver's head in both a vertical and horizontal plane. A controller receives a linear position signal indicating a linear position of an adjustable driver's seat and an angular position signal indicating an angular position of the back-rest of the driver's seat. The controller calculates an estimated location of the driver's head in both the vertical and horizontal plane based at least in part on the linear position and angular position. The controller then changes the orientation of at least one of the three mirrors of the vehicle based on an intersection of the estimated location of the driver's head in the vertical and horizontal planes.

### BACKGROUND

The present invention relates to rear-viewing systems for vehicles. Vehicles such as cars and trucks generally have three rear-view mirrors. One mirror is mounted on the exterior of each side on the vehicle and each mirror is viewable by the driver through the side windows of the vehicle. The third mirror is mounted in the interior of the vehicle and provides an image through the rear window of the vehicle. To safely operate the vehicle, each of the three mirrors are adjusted by the driver.

### SUMMARY

The optimal pitch and yaw position of each mirror in the vehicle depends upon several factors including the position of the driver's height, body shape, and posture as well as the position of an adjustable driver's seat. If the mirrors are not adjusted prior to operating the vehicle, it can be difficult or dangerous to adjust them while the vehicle is moving. Similarly, if the driver shifts in the driver's seat during a trip, the mirrors may no longer be properly positioned at an adequate viewing angle.

In one embodiment, the invention provides a system for adjusting one or more mirrors in a vehicle based on an estimated location of the driver's head in both a vertical and horizontal plane. A controller receives a linear position signal indicating a linear position of an adjustable driver's seat and an angular position signal indicating an angular position of the back-rest of the driver's seat. The controller calculates an estimated location of the driver's head in both the vertical and horizontal plane based at least in part on the linear position signal and angular position signal. The controller then changes the orientation of at least one of the three mirrors of the vehicle based on an intersection of the estimated location of the driver's head in the vertical and horizontal planes.

Some embodiments provide a user-adjustable control to make fine-tuning adjustments directly to one of the vehicle mirrors. These fine-tuning adjustments allow the system to adapt to the user's unique body shape, height, and seating posture. The fine-tuning adjustments are stored to a memory and are used to better estimate the location of the driver's head when the position of the adjustable driver's seat is moved.

In some embodiments, the controller detects when a manual change is made to the orientation of a middle interior mirror of the vehicle. The controller calculates an updated estimated location of the driver's head in the horizontal and vertical planes based at least in part on the detected change in orientation and adjusts the orientation of the right-exterior mirror and the left-exterior mirror accordingly.

In another embodiment, the invention provides a vehicle including an adjustable driver's seat, a left-exterior mirror, a right-exterior mirror, two motors controlling the orientation of the two exterior mirrors, a middle interior mirror, and a position sensor configured to determine the orientation of the middle mirror. A memory stores instructions that, when executed by a controller, cause the controller to receive a linear position signal and angular position signal indicating the linear position of the adjustable driver's seat and the angular position of the back-rest of the driver's seat. The controller also receives a signal indicative of the orientation of the middle-interior mirror. The controller calculates a location of the driver's head in a vertical and horizontal plane based at least in part on the three received variables—seat distance, seat angle, and middle mirror orientation. The controller then changes the orientation of the left-exterior mirror and the right-exterior mirror based on the intersection of the estimated location of the driver's head in the vertical and horizontal planes.

In still another embodiment, the invention provides a method of controlling the orientation of a plurality of rear-view mirrors in a vehicle. The vehicle includes an adjustable driver's seat with a seating-portion and a back-rest portion. The vehicle also includes a left-exterior mirror, a right-exterior mirror, and a middle-interior mirror. According to the method, two signals are received indicating the linear position of the adjustable driver's seat and the angular position of the back-rest portion of the seat. An estimated location of the driver's head is then calculated in both a vertical and a horizontal plane. The orientation of at least one of the mirrors is then changed based on the intersection.

Other aspects of the invention will become apparent by consideration of the detailed description and accompanying drawings.

### BRIEF DESCRIPTION OF THE DRAWINGS

FIG. 1 is a block diagram of the rear-viewing control system according to one embodiment of the invention.

FIG. 2 is a flow-chart illustrating a method of adjusting the yaw position angle of a mirror using the system of FIG. 1.

FIG. 3 is an overhead view of the interior of a vehicle using the system of FIG. 1.

FIG. 4 is a flow-chart illustrating a method of adjusting the pitch position angle of a mirror using the system of FIG. 1.

FIG. 5 is a side-view of the interior of a vehicle using the system of FIG. 1.

FIG. 6 is an overhead view of a user adjusted controller for the system of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

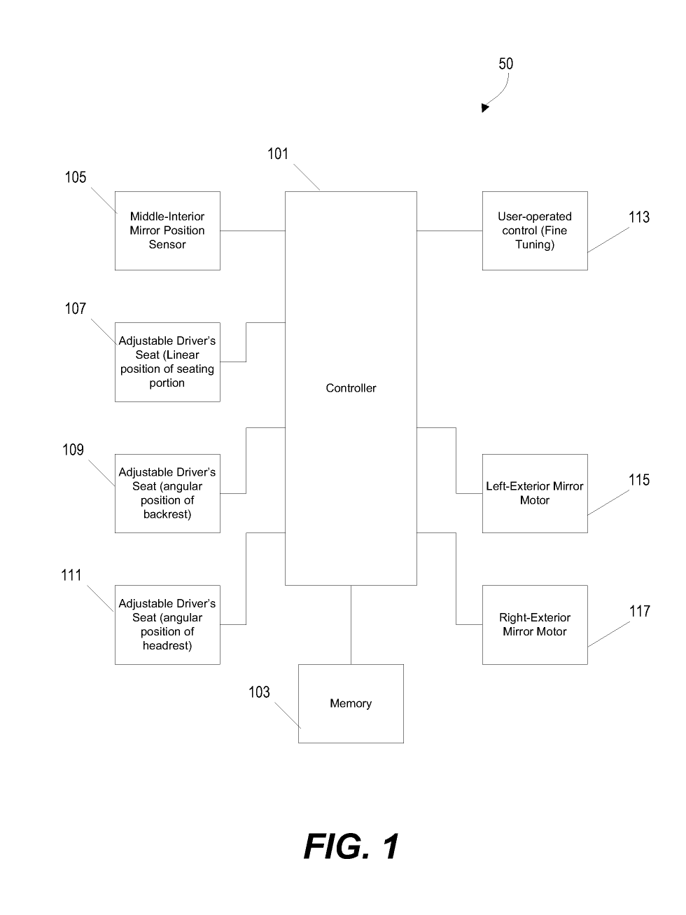

FIG. 1 illustrates a system 50 that includes a controller 101. The controller 101 receives and processes several inputs in order to adjust the orientation of the two exterior side mirrors of the vehicle. The controller 101 is in electronic communication with a memory 103. The memory stores computer instructions that are executed by the processor and other information that is used to determine the correct orientation of the vehicle mirrors. The controller 101 receives input from a position sensor 105 which indicates the orientation of the middle-interior mirror of the vehicle. The controller 101 also receives an input from a driver's seat linear position sensor 107, a driver's seat angular position sensor 109, and a driver's seat headrest position sensor 111. The various position sensors (105, 107, 109, and 111) can be embodied in commercially available position sensors such as potentiometers and Hall Effect sensors. Alternatively, in some mechanically controlled adjustable driver's seats where the linear and angular positions are adjusted by controlled step motors, the position sensors can include logic in the motors configured to monitor the position of the driver's seat as it changes.

The controller 101 also receives an input from a user-operated adjustment control 113. The adjustment control 113 is used to adjust the position of each of the two exterior vehicle mirrors as discussed in detail below.

The controller 101 processes the information provided by the sensors and determines an estimated location of the driver's head. After determining an estimated location of the driver's head, the controller 101 sends a signal to a left-exterior mirror motor 115 and a right-exterior mirror motor 117 to adjust the orientation of the left and right exterior mirrors, respectively.

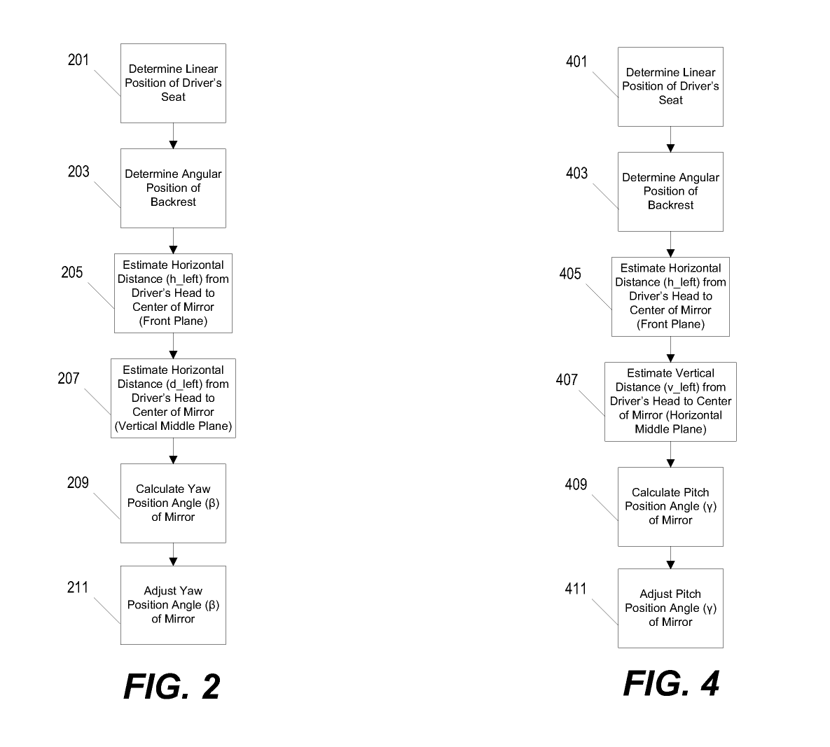

To safely operate a vehicle, each of the three mirrors should be adjusted to provide the driver with a proper sightline. In order to achieve a proper sightline, the yaw angle and the pitch angle of each mirror must be adjusted. FIG. 2 illustrates a method of adjusting the yaw angle of a mirror using the system 50. The controller 101 receives a signal from the linear position sensor 107 (step 201) and a signal from the angular position sensor 109 (step 203). These two values are used to determine the position of the driver's head in a horizontal plane. The dimensions of the adjustable driver's seat are known. Therefore, the distance of the driver's head from a front plane including the mirror can be estimated based on the known dimensions based on the assumption that a driver will usually sit with his head against the headrest portion of the vehicle (step 205). Initially, the controller 101 also assumes that the driver sits in the center of the driver's seat. Therefore, the controller 101 is able to estimate the lateral distance between the driver's head and the mirror (step 207). As discussed in detail below, a user is able to provide fine-tuning adjustments to correct for any errors in these assumptions.

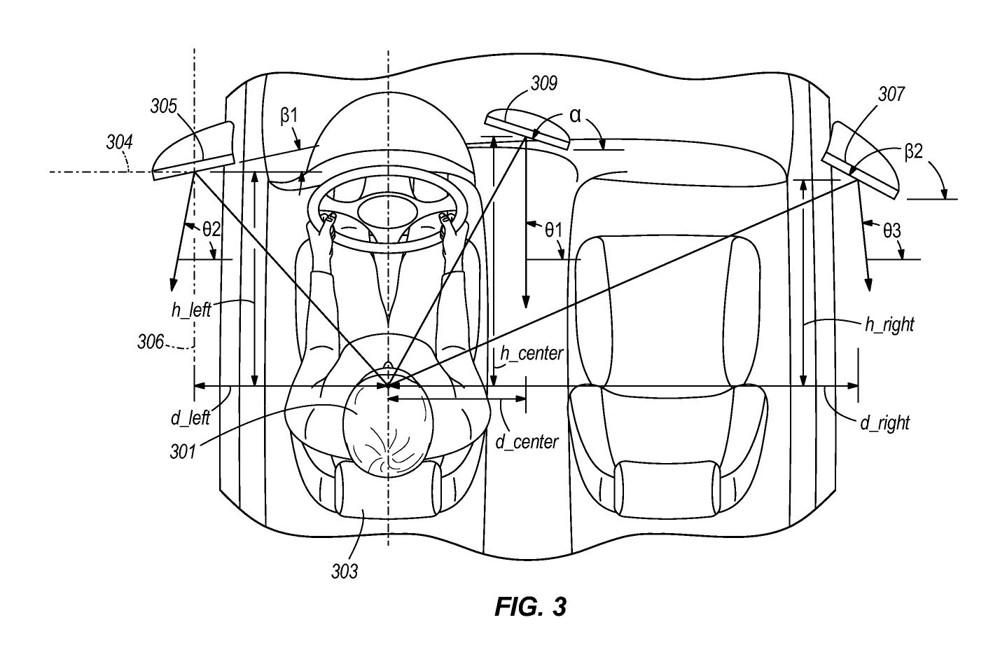

After the controller 101 has determined an estimated location of the driver's head in the horizontal plane, the controller 101 calculates an appropriate yaw angle β for the mirror. FIG. 3 provides an overhead view of a vehicle including the rear-view adjusting system 50. As shown in FIG. 3 and as described above, the driver's head 301 is positioned immediately in front of the headrest portion 303 of the driver's seat. Based on the known dimensions of the seat and the signals received from the position sensors 107, 109, and 111, the controller 101 is able to estimate that the driver's head is a distance h_left from a front plane 304 including the left-exterior mirror 305. The controller also estimates that the driver's head is a lateral distance d_left from a side plane 306 including the left-exterior mirror 305. The controller uses trigonometric functions stored as instructions on the memory to determine an appropriate yaw angle position (β1) of the mirror that will provide a driver positioned at the estimated location with an ideal viewing angle (θ2). In some embodiments, the ideal viewing angle for each mirror is predefined by the manufacturer. In other embodiments, the ideal viewing angle can be adjusted by a technician or by the driver.

Returning to FIG. 2, after the controller 101 has calculated the appropriate yaw angle β for the mirror, the controller 101 operates the left-exterior mirror motor 115 to adjust the mirror 305 to the calculated yaw angle. The method illustrated in FIG. 2 is then repeated for the right-exterior mirror 307. As illustrated in FIG. 3, the controller 101 estimates the linear (h_right) and lateral (d_right) distance between the driver's head and the right mirror 307 and calculates the yaw angle position (β2) that provides the driver with the ideal viewing angle (θ2).

In some embodiments of the invention, the method of FIG. 2 is also repeated to automatically adjust the yaw angle position (α) of the middle-interior mirror 309. However, in the system 50, the position of the middle-interior mirror is manually set by the driver and assists the controller 101 in determining the location of the driver's head. As described above, the controller 101 begins with the assumption that the driver sits in the middle of the driver's seat. However, this is not always the case. Many drivers will lean to the middle of the vehicle or against the driver's side door while driving. In addition, while operating the vehicle, a driver may change positions in the driver's seat. As a consequence, the yaw angle position of the middle-interior mirror 309 is used to estimate the position of the driver's head. The controller 101 assumes that the driver has positioned the middle-interior mirror 309 at a yaw angle position (α) that provides the driver with an ideal viewing angle (θ1). Based on the known dimensions and position of the driver's seat, the controller 101 is able to calculate the linear distance (h_center) between the driver's head and a front plane including the middle-interior mirror 309. Based on the estimated distance (h_center) and the known yaw angle of the center mirror (α) the controller 101 is able to calculate the lateral distance (d_center) between the driver's head and the mirror. This distance can then be used to determine the lateral distance from the driver's head 303 to the left-exterior mirror 305 and the right-exterior mirror 307 (d_left and d_right, respectively) without assuming that the driver is seated in the middle of the driver's seat.

After the controller 101 has determined the correct yaw angle for each mirror, the controller 101 adjusts the pitch of each mirror. FIG. 4 illustrates a method of determining the proper pitch angle of each mirror for a driver based on an estimated position of the driver's head in a vertical plane. The controller 101 again determines a linear position of the driver's seat (step 401) based on a signal received from the linear position sensor 107 and the angular position of the driver's seat (step 403) based on a signal received from the angular position sensor 109. The controller 101 uses these position values to determine a linear distance from the driver's head to each of the mirrors (step 405). In FIG. 4, the controller 101 is adjusting the pitch of the left-exterior mirror 305 and, therefore, determines the linear distance h_left.

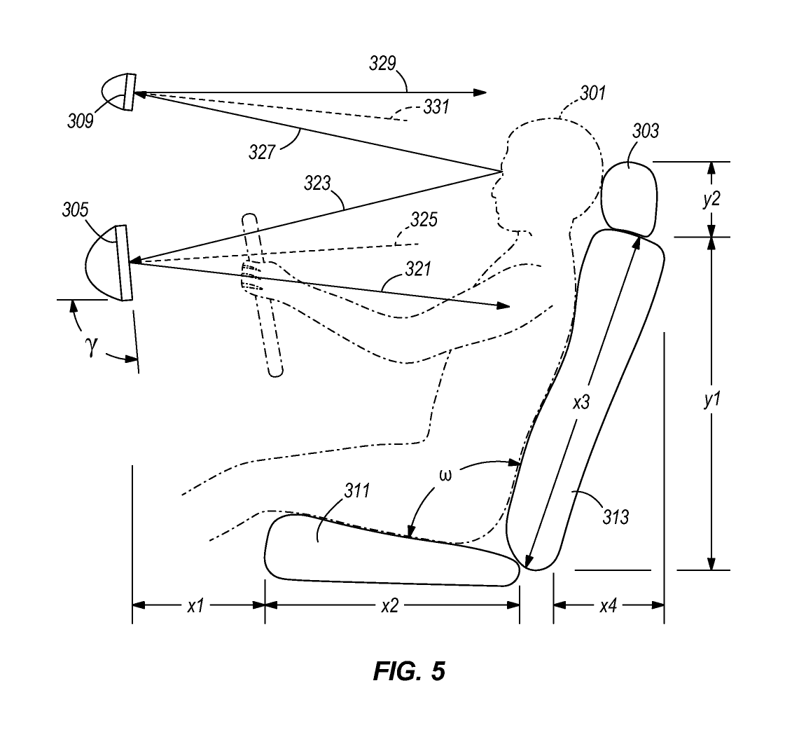

FIG. 5 provides a side-view of the interior of the vehicle and illustrates locations and distances used by the controller 101 to estimate the location of the driver's head 303 in a vertical plane. Information is provided to the controller 101 from position sensors 107, 109, and 111. The controller 101 receives an input from the linear position sensor 107 indicating the linear position of the seating portion 311 of the adjustable driver's seat. This distance is shown as x1. The seating portion 311 has a known depth x2. The controller also receives an input from the angular position sensor 109 indicating the angular position (ω) of a backrest portion 313 of the driver's seat. The controller uses the known angular position (ω) and the known length (x3) of the backrest portion 313 to determine the linear distance (x4) between the seating portion 311 and the top of the backrest portion 313. The linear distance between the driver's head and the left-exterior mirror is then determined by adding the distance between the mirror and the seating portion 311 (x1), the length of the seating portion 311 (x2), and the linear distance added by the angle of the backrest portion 313 (x4). Additionally, if the headrest portion 303 is positioned at an angle, a similar trigonometric function is used to determine the added (or subtracted) linear distance due to the angle of the headrest portion 303. The linear distance is then adjusted to account for the estimated depth of the driver's head to calculate h_left. The estimated depth of the driver's head is initially based on a predefined average. However, this value can be adjusted by fine-tuning the system 50 as described below.

Returning to FIG. 4, after determining the linear distance h_left, the controller 101 estimates the vertical distance (v_left) between the driver's eyes and the mirror (step 407). As described above, the angular position of the backrest 313 of the driver's seat is provided to the controller by the angular position sensor 109. Using the known angle (ω) and the known length of the backrest 313 (x3), the controller 101 is able to calculate the height of the top of the back rest 313 (y1) as illustrated in FIG. 5. If the headrest position sensor 111 indicates that the height or angle of the headrest portion has been changed, the controller adjusts the known height (y2) of the headrest portion accordingly. Because the controller 101 estimates that the driver's head is located at the center of the headrest portion and because the height of the mirror is known, the controller 101 calculates the vertical distance between the driver's head 301 and the left-exterior mirror 305 as v_left=y1+(y2/2)−(height of mirror).

The controller 101 then determines an appropriate pitch angle (γ) for the left-exterior mirror 305 (step 409). The controller 101 accesses the memory to determine the preferred angle of the sightline 321 to be provided by the left-exterior mirror when viewed by the driver (along line 323). A line 325 extending normal from the surface of the mirror bisects the angle between the driver's eye line 323 and the sightline 321 provided by the mirror. The controller 101 uses these known values to calculate an appropriate pitch angle (γ) for the left-side exterior mirror 305. After the angle is determined, the controller operates the left-exterior mirror motor 115 to adjust the pitch angle of the left-exterior mirror 305 (step 411). The method of FIG. 4 is then repeated for the right-exterior mirror 307.

As described above in reference to FIG. 3, the controller in this embodiment can better estimate the location of the driver's head based on the orientation of the middle-interior mirror 309 by estimating the angle of the driver's eye line 327. The driver manually adjusts the orientation of the middle-interior mirror 309 and the controller 101 accesses the memory to determine the preferred angle of the sightline 329. Because a line 331 extending normal from the surface of the mirror will bisect the angle between the driver's eye line 327 and the preferred sightline 329, the controller 101 is able to determine the driver's eye line 327 based on the known angle of the preferred sightline 329 and the known orientation of the middle-interior mirror 309. The controller 101 uses the calculated angle of line 327 and the known seat position variables described above to better estimate the location of the driver's head 303.

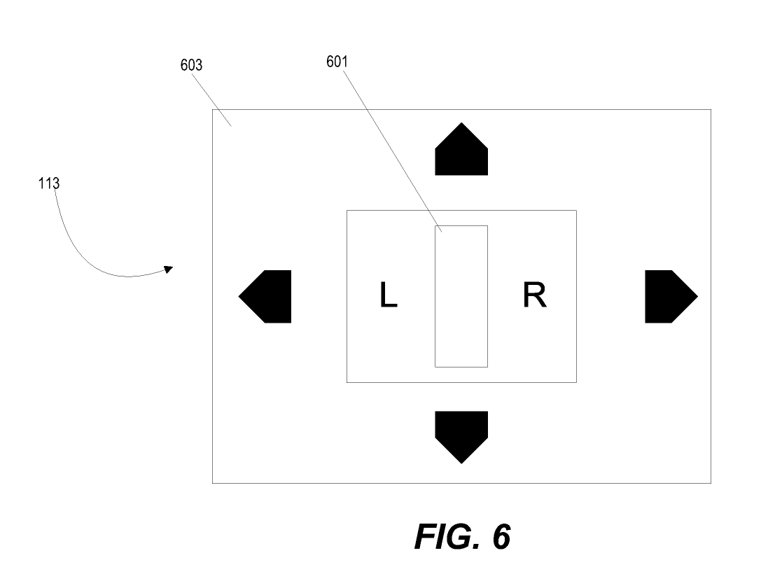

If the calculated orientation based on the known and calculated variables described above fails to provide an optimal pitch angle of the left-exterior mirror 307, the controller 101 further compensates for the driver's height and seating posture by storing fine-tuning information provided by the driver. FIG. 6 provides a detailed view of the user-adjusted control 113. The control includes a two-way interior switch 601 surrounded by a four-way exterior switch 603. The interior switch 601 is moved to the left or to the right to select either the left-exterior mirror 305 or the right-exterior mirror 307. The interior switch 601 can also be placed into the neutral middle position. When either the left-exterior mirror 305 or the right-exterior mirror 307 is selected using the interior switch 601, the user can adjust the orientation of the mirror using the exterior switch 603. The yaw angle of the mirror is adjusted using the left and right arrow-shaped buttons while the pitch angle of the mirror is adjusted using the up and down arrows. When the interior switch 601 is returned to the neutral position, the controller 101 controls the orientation of the left-exterior mirror 305 and the right-exterior mirror 307 according to the methods of FIGS. 2 and 4.

After the controller 101 has made the initial adjustments based on the position of the seat and the orientation of the middle interior mirror. The driver can fine-tune the adjustment by using the control 113 to adjust the orientation of the left-exterior mirror 305 and the right-exterior mirror 307. As shown in FIG. 3, the driver's head 301 (or more particularly, the driver's eyes) are located at approximately the location of the intersection of the three eyelines extending from each of the three mirrors. The angle of each eyeline is determined based on the known, manually adjusted orientation of the three mirrors and the predetermined ideal viewing angle for each mirror. As described above, a line normal to the surface of the mirror will bisect the angle caused by the driver's eyeline and the ideal viewing angle. If the controller 101 determines that the three eyelines intersect at a location different from the original estimated location of the driver's head (e.g., if the driver leans forward while driving), the controller 101 will make future adjustments based on a head location determined by the intersection of the eyelines. For example, if the eyelines intersect at a location 4 inches down and 2 inches forward of the original estimated head location (e.g., the driver leans toward the center counsel while driving), the controller 101 will make future adjustments to the mirrors using an estimated head location based on these fine-tuning adjustments.

After the fine-tuning settings have been set, the controller 101 can account for these preferences when the position of the driver's seat is changed or when the orientation of the middle-interior mirror 309 is moved. For example, as the seat is moved forward, the controller 101 re-executes the methods of FIGS. 2 and 4 and calculates an updated estimated location of the driver's head based on the new seat position and the stored fine-tuning settings.

Different fine-tuning settings can be stored for different drivers of the vehicle. In some embodiments, the fine-tuning settings can be selected by the driver using a button on the vehicle interior. In other embodiments, the driver will use a remote control to unlock the doors or start the engine of the vehicle. If there are two different drivers of the same vehicles, each driver will use a different remote control. In such embodiments, the signal sent from the remote control to instruct the vehicle to unlock the doors or start the engine will also inform the vehicle which driver will be using the vehicle. The controller 101 automatically adjusts the adjustable driver's seat to the last position used by the identified driver and adjusts the mirrors based on the position of the drivers seat and the stored fine-tuning settings for that driver.

The embodiments described above are exemplary of the invention. In some alternative embodiments, the controller 101 receives additional information from a weight sensor that identifies the center of gravity of the driver. This weight information is used by the controller to adjust the estimated location of the driver. In still other alternatives, video and object recognition technologies are used to confirm the estimated location of the driver's head.

Additionally, the embodiments described above refer to a “controller” that executes instructions stored on a memory. The controller in the described embodiments can be a microcontroller with an internal or external memory. However, in other embodiments, the controller can include other electrical circuits capable of controlling the orientation of the mirrors of a vehicle based on observed variables.

Furthermore, the terms “linear,” “lateral,” and “vertical” are used above to refer to specific coordinate systems of the vehicle. Linear distances refer to distances along a line between the front and rear of the vehicle. Lateral distances refer to distances along a line from one side of the vehicle to the other. Vertical distances refer to distances along a line between the top and bottom of the vehicle.

Thus, the invention provides, among other things, a system for adjusting the orientation of a plurality of rear-view mirrors on a vehicle based on stored information and observed conditions such as the location and position of a driver seat. Various features and advantages of the invention are set forth in the following claims.

What is claimed is:

1. A system for controlling an orientation of rear-viewing mirrors in a vehicle, the vehicle including a left-exterior mirror, a right-exterior mirror, a middle-interior mirror, and an adjustable driver's seat, the adjustable driver's seat including a back-rest portion and a seating portion, the system comprising a controller configured to:
receive a linear position signal indicating a linear position of the adjustable driver's seat relative to the vehicle;
receive an angular position signal indicating an angular position of the back-rest portion of the adjustable driver's seat relative to the seating portion of the adjustable driver's seat;
calculate an estimated location of a driver's head in a horizontal plane based at least in part on the linear position signal and the angular position signal;
calculate an estimated location of the driver's head in a vertical plane based at least in part on the linear position signal and the angular position signal; and
change an orientation of at least one of the left-exterior mirror, the right-exterior mirror, and the middle-interior mirror based on an intersection of the estimated location of the driver's head in the vertical plane and the estimated location of the driver's head in the horizontal plane.

2. The system of claim 1, wherein the controller is further configured to:
receive a fine-tuning setting through a user-adjustable control, wherein receiving the fine-tuning setting adjusts the orientation of at least one of the left-exterior mirror, the right-exterior mirror, and the middle-interior mirror; and
store the fine-tuning setting to a memory.

3. The system of claim 2, wherein the controller is further configured to:
receive an updated linear position signal indicating a change in the linear position of the adjustable driver's seat relative to the vehicle; and
adjust the orientation of at least one of the left-exterior mirror, the right-exterior mirror, and the middle-interior mirror based at least in part on the updated linear position signal and the fine-tuning setting.

4. The system of claim 3, wherein the controller is further configured to
calculate an updated estimated location of the driver's head in the horizontal plane based at least in part on the updated linear position signal and the fine-tuning setting; and
calculate an updated estimated location of the driver's head in the vertical plane based at least in part on the updated linear position signal and the fine-tuning setting,
wherein the orientation of the at least one of the left-exterior mirror, the right-exterior mirror, and the middle-interior mirror is adjusted based at least in part on the updated estimated location of the driver's head in the horizontal plane and the updated estimated location of the driver's head in the vertical plane.

5. The system of claim 1, wherein the controller is further configured to
receive a manual adjustment signal indicative of a manual change of the orientation of one of the left-exterior mirror, the right-exterior mirror, and the middle-interior mirror;
calculate an updated estimated location of the driver's head in the horizontal plane based at least in part on the manual adjustment signal;
calculate an updated estimated location of the driver's head in the vertical plane based at least in part on the manual adjustment signal; and
adjust the orientation of the other two of the left-exterior mirror, the right-exterior mirror, and the middle-interior mirror based at least in part on the updated estimated location of the driver's head in the horizontal plane and the updated estimated location of the driver's head in the vertical plane.

6. The system of claim 5, wherein the manual adjustment signal is indicative of the manual change in the orientation of the middle-interior mirror.

7. The system of claim 1, wherein the controller is further configured to receive a headrest position signal indicative of a position of a headrest portion of the adjustable driver's seat relative to the back-rest portion of the adjustable driver's seat, and wherein the estimated location of the driver's head in the horizontal plane and the estimated location of the driver's head in the vertical plane are calculated based at least in part on the headrest position signal.

8. A method of controlling an orientation of each of a plurality of rear-view mirrors in a vehicle, the vehicle including an adjustable driver's seat with a seating portion and a back-rest portion, a left-exterior mirror, a right-exterior mirror, and a middle-interior mirror, the method comprising:
receiving a linear position signal indicating a linear position of the adjustable driver's seat relative to the vehicle;
receiving an angular position signal indicating an angular position of the adjustable driver's seat related to the seating portion;
calculating an estimated location of a driver's head in a horizontal plane based at least in part on the linear position signal and the angular position signal;
calculating an estimated location of the driver's head in a vertical plane based at least in part on the linear position signal and the angular position signal; and
changing the orientation of at least one of the left-exterior mirror, the right-exterior mirror, and the middle-interior mirror based on an intersection of the estimated location of the driver's head in the vertical plane and the estimated location of the driver's head in the horizontal plane.

9. The method of claim 8, further comprising:
receiving a fine-tuning setting through a user-adjustable control, wherein receiving the fine-tuning setting adjusts the orientation of at least one of the left-exterior mirror, the right-exterior mirror, and the middle-interior mirror; and
storing the fine-tuning setting to a memory.

10. The method of claim 9, further comprising:
receiving an updated linear position signal indicating a change in the linear position of the adjustable driver's seat relative to the vehicle; and
adjusting the orientation of at least one of the left-exterior mirror, the right-exterior mirror, and the middle-interior mirror based at least in part on the updated linear position signal and the fine-tuning setting.

11. The method of claim 10, further comprising:
calculating an updated estimated location of the driver's head in the horizontal plane based at least in part on the updated linear position signal and the fine-tuning setting; and
calculating an updated estimated location of the driver's head in the vertical plane based at least in part on the updated linear position signal and the fine-tuning setting.

12. The method of claim 8, further comprising:
receiving a manual adjustment signal indicative of a manual change in the orientation of the left-exterior mirror, the right-exterior mirror, and the middle-interior mirror;
calculating an updated estimated location of the driver's head in the horizontal plane based at least in part on the manual adjustment signal;
calculating an updated estimated location of the driver's head in the vertical plane based at least in part on the manual adjustment signal; and
adjusting the orientation of the other two of the left-exterior mirror, the right-exterior mirror, and the middle interior middle based at least in part on the updated estimated location of the driver's head in the horizontal plane and the updated estimated location of the driver's head in the vertical plane.

13. The method of claim 12, wherein the manual adjustment signal is indicative of the manual change in the orientation of the middle-interior mirror.

14. The method of claim 8, further comprising receiving a headrest position signal indicative of a position of a headrest portion of the adjustable driver's seat relative to the back-rest portion, and wherein the estimated location of the driver's head in the horizontal plane and the estimated location of the driver's head in the vertical plane are calculated based at least in part on the headrest position signal.
